(19) United States
(12) Patent Application Publication
(10) Pub. No.: US 2026/0224986 A1
(43) Pub. Date: Aug. 6, 2026

(54) USER DEVICE CONFIGURED TO PROVIDE A COMPUTER IMPLEMENTED GAME

(71) Applicant: KING.COM LIMITED, St. Julian's (MT)

(72) Inventors: Marc PESTKA, Barcelona (ES); Issa AFRAM, Stockholm (SE)

(21) Appl. No.: 19/046,775

(22) Filed: Feb. 6, 2025

(51) Int. Cl. A63F 13/537

(52) U.S. Cl. CPC A63F 13/537

(57) ABSTRACT

A user device configured to provide a computer implemented game, comprising: a display configured to display a computer implemented game having a game play area comprising a plurality of cards, a stack of cards with a foundation card, and a hold slot, wherein in a first mode the hold slot is configured to either be empty or to hold a foundation card, and in a second mode the hold slot is blocked; a user interface configured to receive a first user input when a user engages with a first card in a first move; and a processor configured to determine, when the hold slot is blocked, in response to the first user input that one or more conditions associated with the hold slot have been met, and when the one or more conditions have been met to cause the hold slot to be in the first mode.

### FIELD OF THE INVENTION

Embodiments of this application relate to a user device configured to provide a computer implemented game.

Some embodiments may relate to engaging users or players in a computer game executable in an online or offline environment.

### BACKGROUND OF THE INVENTION

In the field of computer-implemented games, there are many technical challenges facing the designer of such computer implemented games when considering how, for example, the user interface is to be controlled in the context of computer devices available to play the game.

One technical challenge can involve allowing a game to be fun and compelling even when there is limited display resource available, such as when a computer implemented game is being played on a smartphone, tablet or other minicomputer. Another significant challenge is that of user engagement. Engagement involves designing game play to be engaging and rewarding to players. This typically requires games to be easily understood at their simplest or introductory levels, providing rewarding game play with quite simple game mechanics, but becoming progressively more challenging so that players are not bored, but remain engaged and develop rewarding skills. Effective engagement requires various forms of feedback to reinforce player sense of success and accomplishment.

A common genre of computer implemented casual games are based on card games, for example solitaire card games. Solitaire card games are where the player manipulates game objects, for example in the form of cards, to achieve a game objective such as the removal of cards from a game play area setting.

A technical challenge exists when introducing complexity into such games. A technical challenge may arise for example when there is limited display resource available and/or in the providing of effective user engagement, such as described previously.

This patent specification describes not only various ideas and functions, but also their creative expression. A portion of the disclosure of this patent document therefore contains material to which a claim for copyright is made and notice is hereby given: Copyright King.com Limited 2025 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records but reserves all other copyright rights whatsoever. No express or implied license under any copyright whatsoever is therefore granted.

### SUMMARY OF THE INVENTION

According to a first aspect, there is provided a user device configured to provide a computer implemented game, the user device comprising: a display configured to display a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked; a user interface configured to receive a first user input when a user engages with a first card in a first move; and a processor configured to determine, when the hold slot is blocked, in response to the first user input that one or more conditions associated with the hold slot have been met, and when the one or more conditions have been met to cause the hold slot to be in the first mode.

The processor may be configured to cause the hold slot to be in the second mode when a blocking object is provided in the hold slot.

The blocking object may comprise a blocking card.

The user interface may be configured to receive a second user input when a user engages with a second card in a second move, the hold slot being in the first mode, and the processor may be configured to determine, in response to the second user input, that the blocking object is activated, and to cause the blocking object to be moved to the hold slot such that the hold slot is changed from the first mode to the second mode.

The blocking object may at least partially underly the second card, and the processor may be configured to determine that the blocking object is activated when the second card is removed from the game play area.

The one or more conditions may comprise two or more actions and the processor may be configured to cause the display to display the blocking object in the hold slot in dependence on a number of the two or more actions which have been completed.

The two or more actions may comprise two or more moves which satisfy a criterion.

The processor may be configured to cause the display to display the blocking object in the hold slot such that as more of the two or more actions have been completed, less of the hold slot is occupied by the blocking object.

The processor may be configured to cause the display to display the hold slot without the blocking object when the one or more conditions have been met.

The processor may be configured to cause the hold slot in the second mode to be blocked such that a foundation card which is moved to the hold slot cannot be moved back to being the foundation card of the stack of cards.

The display may be configured to display one or more blocking objects on the game play area when the hold slot is blocked.

The processor may be configured to prevent selection of a card in the game play area which underlies at least partially one of the one or more blocking objects.

The user interface may be configured to receive a third user input when a user engages with a third card in a third move, the hold slot being in the second mode, and the processor may be configured to cause, in response to the third user input causing one or more conditions to be satisfied, a blocking object item to be provided for a blocking object item.

The processor may be configured to cause the display the blocking object item together with one of the one or more blocking objects.

The processor may be configured to cause the one or more blocking items to be removed from the game play area when each blocking object is associated with a blocking object item.

The processor may be configured to cause the hold slot to have the first mode when all of the one or more blocking objects have been removed from the game play area.

The one or more conditions which cause the blocking object item to be provided, may comprise moving a foundation card to the hold slot.

The processor may be configured to modify the foundation card which was moved to the hold slot to provide the blocking object item.

According to a second aspect, there is provided a computer implemented method performed by a user device, the user device having a processor, a display and a user interface, the method comprising: displaying, by the display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked; receiving, via the user interface, a first user input when a user engages with a first card in a first move; and determining, by the processor, when the hold slot is blocked, in response to the first user input that one or more conditions associated with the hold slot have been met, and when the one or more conditions have been met to cause the hold slot to be in the first mode.

The method may comprise causing the hold slot to be in the second mode when a blocking object is provided in the hold slot.

The blocking object may comprise a blocking card.

The method may comprise receiving, via the user interface, a second user input when a user engages with a second card in a second move, the hold slot being in the first mode, and determining, by the processor, in response to the second user input, that the blocking object is activated, and causing the blocking object to be moved to the hold slot such that the hold slot is changed from the first mode to the second mode.

The blocking object may at least partially underly the second card, and the method may comprise determining, by the processor, that the blocking object is activated when the second card is removed from the game play area.

The one or more conditions may comprise two or more actions and the method may comprise causing, by the processor, the display to display the blocking object in the hold slot in dependence on a number of the two or more actions which have been completed.

The two or more actions may comprise two or more moves which satisfy a criterion.

The method may comprise causing, by the processor, the display to display the blocking object in the hold slot such that as more of the two or more actions have been completed, less of the hold slot is occupied by the blocking object.

The method may comprise causing, by the processor, the display to display the hold slot without the blocking object when the one or more conditions have been met.

The method may comprise causing, by the processor, the hold slot in the second mode to be blocked such that a foundation card which is moved to the hold slot cannot be moved back to being the foundation card of the stack of cards.

The method may comprise causing, by the processor, the display to display one or more blocking objects on the game play area when the hold slot is blocked.

The method may comprise preventing, by the processor, selection of a card in the game play area which underlies at least partially one of the one or more blocking objects.

The method may comprise receiving via the user interface a third user input when a user engages with a third card in a third move, the hold slot being in the second mode, and causing, by the processor, in response to the third user input satisfying one or more conditions, a blocking object item to be provided for a blocking object item.

The method may comprise causing, by the processor, the display to display the blocking object item together with one of the one or more blocking objects.

The method may comprise causing, by the processor, the one or more blocking items to be removed from the game play area when each blocking object is associated with a blocking object item.

The method may comprise causing, by the processor, the hold slot to have the first mode when all the one or more blocking objects have been removed from the game play area.

The one or more conditions which cause the blocking object item to be provided, may comprise moving a foundation card to the hold slot.

The method may comprise modifying, by the processor, the foundation card which was moved to the hold slot to provide the blocking object item.

According to a third aspect, there is provided a user device configured to provide a computer implemented game, the user device comprising: a display configured to display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked by a blocking object; a user interface configured to receive a first user input when a user engages with a first card in a first move, the hold slot being in the first mode; a processor configured to determine, in response to the first user input, that the blocking object is activated and to cause the blocking object to be moved to the hold slot such that the hold slot is changed from the first mode to the second mode.

According to a fourth aspect, there is provided computer implemented method performed by a user device, the user device having a processor, a display and a user interface, the method comprising: displaying, by the display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked by a blocking object; receiving, via the user interface, a first user input when a user engages with a first card in a first move, the hold slot being in the first mode; determining, by the processor, in response to the first user input, that the blocking object is activated; and causing, by the at least one processor, the blocking object to be moved to the hold slot such that the hold slot is changed from the first mode to the second mode.

According to a fifth aspect, there is provided a user device configured to provide a computer implemented game, the user device comprising: a display configured to display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked such that a foundation card which is moved to the hold slot cannot be moved back to being the foundation card of the stack of cards; a user interface configured to receive, a first user input when a user engages with the foundation card to move the foundation card to the hold slot in a first move, the hold slot being in the second mode; a processor configured to determine, in response to the first move, when the hold slot is blocked, that one or more conditions associated with the hold slot have been met, and cause, the hold slot to be in the first mode when the one or more conditions have been met to cause the hold slot to be in the first mode.

According to a sixth aspect, there is provided there is provided computer implemented method performed by a user device, the user device having a processor, a display and a user interface, the method comprising: displaying, by the display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked such that a foundation card which is moved to the hold slot cannot be moved back to being the foundation card of the stack of cards; receiving, via the user interface, a first user input when a user engages with the foundation card to move the foundation card to the hold slot in a first move, the hold slot being in the second mode; determining, by the processor, in response to the first move, when the hold slot is blocked, that one or more conditions associated with the hold slot have been met; and causing by the processor, the hold slot to be in the first mode when the one or more conditions have been met to cause the hold slot to be in the first mode.

According to a seventh aspect, there is provided a user device configured to provide a computer implemented game, the user device comprising: a display configured to display, a computer implemented game, the computer implemented game comprising a game play area comprising a plurality of cards, a first card of the plurality of cards has a first mode when the card is available to be played and a second mode where the card is not available to be played, a stack of cards with a foundation card, and a hold slot, wherein the hold slot is configured to either be empty or to hold a foundation card; a user interface configured to receive a first user input when a user engages with a foundation card in a first move to move the foundation card to the hold slot; a processor configured to determine, in response to the first user input, that the foundation card satisfies one or more conditions such that first card changes from the second mode to the first mode.

According to an eight aspect, there is provided a user device configured to provide a computer implemented game, the user device comprising: a display configured to display, a computer implemented game, the computer implemented game comprising a game play area comprising a plurality of cards, a stack of cards with a foundation card; a user interface configured to receive a first user input when a user engages with a first card in the game play area; a processor configured to determine, in response to the first user input, that the first card satisfies one or more conditions such that first card is moved from a first position to a second position in the game play area and a characteristic of the first card changes from a first characteristic to a second characteristic.

According to some aspects, there is provided a program product comprising a computer-readable storage device including a computer-readable program for providing a computer-implemented game, wherein the computer-readable program when executed on a computer causes the computer to perform any one or more of the method steps described previously.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

### BRIEF DESCRIPTION OF THE DRAWINGS

Embodiments will now be described by way of the accompanying drawings in which:

FIG. 1 shows an example user device configured to provide some embodiments;

FIG. 2 shows an example system in which some embodiments may be provided;

FIG. 3 shows an example of a computer-implemented game providing a solitaire-type card game having a hold slot;

FIGS. 4a to 4c show an example where the hold slot is blocked from being used;

FIG. 4d shows a first method of some embodiments;

FIGS. 5a and 5b show an example where the hold slot is used to make an unavailable card available;

FIG. 5c shows a second method of some embodiments;

FIGS. 6a to 6e show an example where the hold slot is used to remove blocking objects;

FIG. 6f shows a third method of some embodiments;

FIG. 7 schematically shows use of a booster object to remove a card in the card slot;

FIG. 8 schematically shows a card associated with a colour restriction provided in some embodiments of the computer implemented game;

FIG. 9 schematically shows a card associated with a value restriction provided in some embodiments of the computer implemented game;

FIG. 10 schematically shows two linked cards provided in some embodiments of the computer implemented game;

FIGS. 11a and 11b schematically shows a so-called flying card provided in some embodiments of the computer implemented game;

FIG. 12 is a schematic diagram showing the modules and functions associated with carrying out the operating of various embodiments; and

FIG. 13 shows another method of some embodiments.

### DESCRIPTION OF PREFERRED EMBODIMENTS

The terms user and player are used interchangeably throughout this document and no specific meaning is intended using one or the other unless the context suggests otherwise. In the following description of various implementations of the embodiments, reference is made to the accompanying drawings which form a part thereof, and in which is shown by way of illustration various implementations in which the invention may be utilized. It is to be understood that other implementations may be utilized, and structural and functional modifications may be made without departing from the scope of the present invention.

A person skilled in the art will realise that the different approaches to implementing the computer game is not exhaustive, what is described herein are certain preferred embodiments. It is possible to implement the computer game in a number of variations.

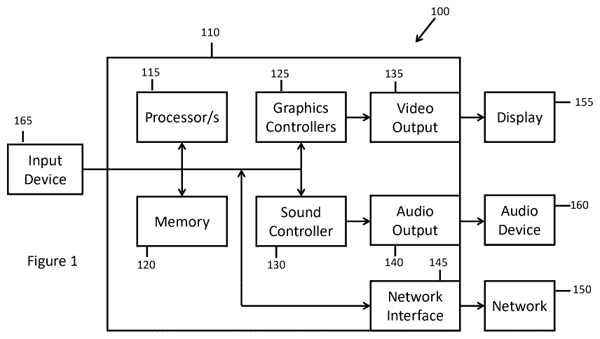

A schematic view of a user device 100 according to an embodiment is shown in FIG. 1. All of the blocks shown are implemented by suitable circuitry. The blocks may be implemented in hardware and/or software. The user device may have a control part 110.

The control part may comprise one or more processors 115 and one or more memories 120.

The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The control part 110 has an interface 145 allowing the device to be able to communicate with a network 150 such as the Internet or other communication infrastructure.

The video output 135 is provided to a display 155. The audio out 140 is provided to an audio device 160 such as a speaker and or earphone(s).

The device 100 has an input device 165. The input device can take any suitable format and can be one or more of a keyboard, mouse, touch screen, joystick or game controller. It should be appreciated that the display 155 may in some embodiments also provide the input device 165 by way of an integrated touch screen for example.

The blocks of the control part 110 are configured to communicate with each other by an interconnect such as a bus or any other suitable interconnect and/or by point-to-point communication.

It should be appreciated that in some embodiments, the control part may be implemented by one or more integrated circuits, at least in part. The control part may be implemented by one or more processors and one or more memories, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

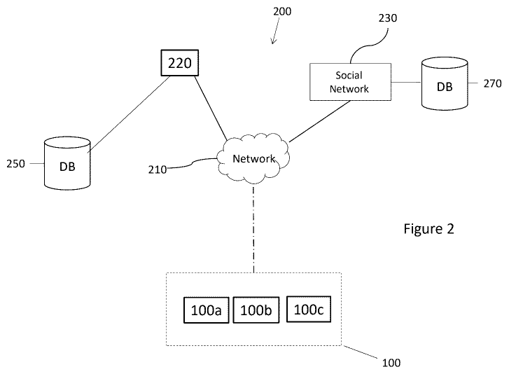

FIG. 2 schematically shows a system 200 according to an embodiment. The system 200 comprises a server 220 which may store or be in communication with database 250 which may store game player's details, profiles, statistics etc. In practice, one or more databases 250 may be provided. Where more than one server 220 is provided, the database(s) 250 may be provided in one server 220 or across two or more servers. The server 220 may also have a games data function. This may comprise one or more units of memory to store the computer game program and user behaviour data, and a processor to run the games program and process the user behaviour data.

The server 220 may communicate via, for instance, the internet 210 to one or more client or user devices 100, shown in FIG. 2 by way of example as user devices 100a, 100b and 100c. There may be connections, via the network 210, to a social network 230, for example, Facebook™. The social network 230 may also be connected to a database 270 storing social user interaction details, for instance, user to user interaction maps, friend lists, location history etc. In practice, one or more databases 270 may be provided.

It should be appreciated that embodiments may be deployed in different system architectures. For example, the computer game may be implemented as a computer game that is stored in the memory of the user device and is run on the processor of the user device. However, the server 220 may handle some elements of the game in some embodiments. By way of example only, a Java game applet may be provided to the user device 100 and the locally running Java applet will generate, for example, the graphics, sounds, and user interaction for the game play on the user device. Some data may be fed back to the server to allow interaction with other players. The data which is fed back may alternatively or additionally allow scoring and/or cross platform synchronization.

In some embodiments, the game may be implemented by a computer program. The computer program may be stored on the user device. that is stored in a memory of the system, for example the server, and which runs on a processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

It should be appreciated that some embodiments may be provided as stand-alone games on the user device.

In the following, reference is made to a or the processor. It should be appreciated that a or the processor may be provided by one processor or more than one processor.

In the following, reference is made to a or the memory. It should be appreciated that a or the memory may be provided by one processor or more than one memory.

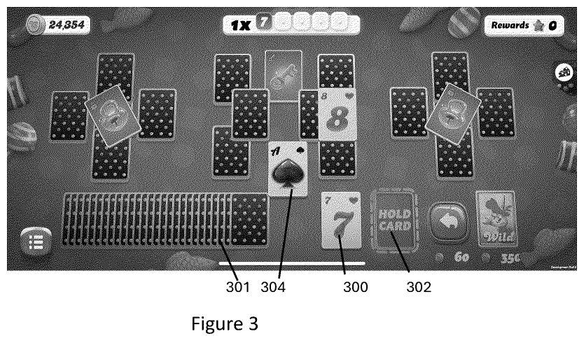

FIG. 3 shows an example of a computer-implemented game providing a solitaire-type card game.

In some embodiments, the solitaire-type card game may be a Tri Peaks type game. A Tri Peaks solitaire game is sometimes referred to as three peaks, tri towers, or triple peaks. Broadly speaking, the game is based on using a deck of cards, and the objective is to clear three peaks made up of cards. However, it should be appreciated that in other embodiments, the solitaire-type card game may be different from the Tri Peaks type game.

The number of cards in some embodiments may be more or less than 52 cards.

In some embodiments, the cards that need to be removed may be arranged in an arrangement different from three peaks.

A user selects, via the user interface, a foundation card of a play stack 300. The play stack may sometimes be referred to as a stockpile.

The play stack generally comprises a set of cards 301. In the example of FIG. 3, the set of cards 301 is displayed on the display in a fan-out arrangement. In this way, a user is provided with a visual indication of the number of cards in the set of cards. As the cards from the set of cards are used up, the processor is configured to cause the display to be updated to show the remaining number of cards in the set of cards 301.

The memory is configured to store data about the set of cards. The memory may be configured to store data about the position of each card and one or more characteristics of the card. For example, the suit of the card and the number associated with the card may be stored.

The playable card of the play stack is referred to as a foundation card. The playable card may be visualised as being at the top of the play stack in some embodiments. The user has the option to select the foundation card and move the card via the user interface to a hold position 302. The hold position is referred to as a hold slot in this document. The data of the foundation card is now stored in relation to the hold position 302. The processor of the user device will then retrieve data from the memory for the next card of the play stack. The processor then controls the display to display the next card of the play stack 300 as the foundation card, assuming that there is at least one remaining card in the play stack.

The user can, via the user interface, select the card in the hold position 302. For example, the user can tap the card displayed on the display (where the display also provides a user interface) to select that card. In response to receiving that input via the user interface, the processor is configured to cause the display to show the card that was in the hold position on the top of the play stack 300. The memory is updated to reflect the change in position of the card that was in the hold position. The memory is updated to indicate that the hold slot has no card. The user is then able to select another card from the top of the play stack 300.

In one example of game play, the aim is to remove cards from the game play area 304. The game play area may be referred to as a tableau. The cards in the game play area may be displayed on the display face up or face down. When a card is displayed face up, the suit of the card, the color associated with the card, and the number may be at least partially visible. It should be appreciated that one or more cards may be at least partially covered by one or more other cards.

For example, a card in the game play area can be removed from the game play area when that card is matched with the foundation card. For example, the user provides input via the user interface to select a card in the game play area. The processor determines, based on the user input, which card in the game play area has been selected. The processor determines if the card that has been selected satisfies one or more match conditions with respect to the foundation card. For example, the processor may determine if the card that has been selected has a number that is one more or one less than the number of the foundation card.

The one or more match conditions may vary depending on which level of the computer-implemented game is being played.

The one or more match conditions may vary depending on the card in the game play area and/or the foundation card 302.

If the processor determines that the card that has been selected satisfies the one or more match conditions with respect to the foundation card, then the processor is configured to cause the selected card to be removed from the game board. The display is caused by the processor to display an updated play area from which the selected card has been removed. The memory is updated to reflect the removal of the card from the game play area.

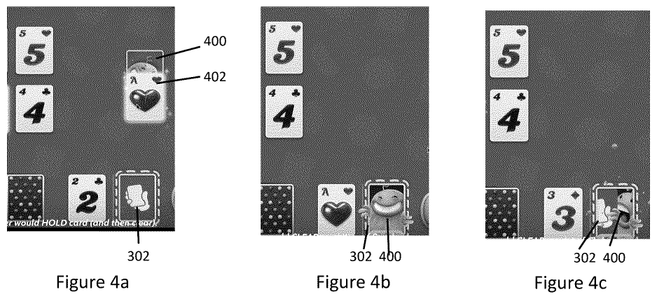

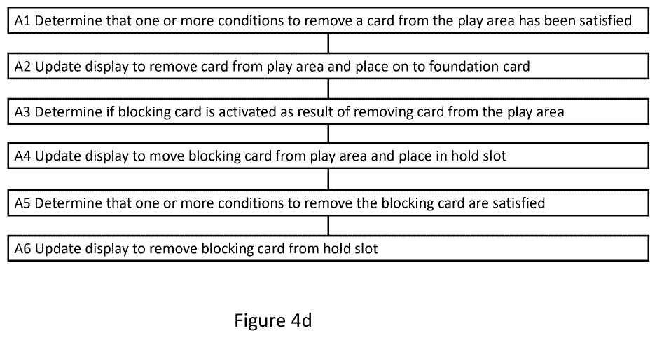

Reference is made to FIGS. 4a to 4c which shows an example of a modification to the hold slot features which may be used in one or more levels of the computer implemented game as outlined in relation to FIG. 3.

In some embodiments, the hold slot may be blocked from being used by a blocker. In some embodiments, the blocker may be a blocker card. However the blocker may be visualised in different way to a card.

The blocker may be removed from the hold slot in response to one or more conditions being satisfied in the computer implemented game.

In the example of FIG. 4a, the blocker card 400 is in the game play area and is underlying at least partially a first card 402. In response to an input received from the user via the user interface, the first card 402 is selected. The processor is configured to determine that the first card is to be moved and that the at least one blocker card is uncovered. In some embodiments, when the blocker card is uncovered, the processor is configured to determine one or more actions in relation to the blocker card.

For example, in some embodiments, the processor is configured to cause the position of the blocker card to change to the position shown in FIG. 4b. In FIG. 4b, the at least one blocker card is located in the hold slot 400.The processor may be configured to cause the blocker card to immediately move to the position shown in FIG. 4b or after a time delay. In other embodiments, the processor is configured to cause the position of the blocker card to change the position shown in FIG. 4b only when one or more conditions are satisfied.

When the blocker card is located in the hold slot, the hold slot is blocked, by the processor, from being used by the user. In other words, the user is unable to select a card and move that card to the hold slot. The processor is configured to prevent the user from providing an input which causes a foundation card to move the hold slot when the blocker card 400 is in the hold slot.

The processor may be configured to cause the display to display the hold slot with a visual indication to indicate that the user is not able to move a foundation card to the hold slot. In some embodiments, the visual indication may be provided by the presence of the blocker card or other indication. In the example shown in FIG. 4b, an animation of a character is displayed in the hold slot when the hold slot is unavailable.

In some embodiments, the processor is configured to determine that one or more conditions have been satisfied in order to cause the hold slot to be available again to the user. The one or more conditions may be any suitable condition or conditions. For example, a user may be required to remove one or more cards for each of three consecutive foundation cards. Another condition may be to provide a sequence of N cards on one foundation card, where N is an integer. In some examples, N may be three or more.

As shown in FIG. 4c, the processor may be configured to cause the display to display information which indicates progress in removing the blocker card. In the example shown in FIG. 4c, the blocker is visualised as being pushed out of the hold slot as progress is made in meeting the one or more conditions required to remove the blocker card. However, this is by way of example only and in other embodiments, a different visual indication may be used to indicate the progress in removing the blocker card from the hold slot. For example, a progress meter or the like may be displayed.

In some embodiments, the processor may be configured to cause information to be displayed on the display which indicates to the user the one or more conditions which need to be satisfied in order for the hold slot be to be available again the user. The processor may for example determine via the user interface that the user is attempting to move a foundation card to the hold slot or has selected the hold slot. In response to this determination, the processor may be configured to cause the information to be displayed on the display which indicates to the user the one or more conditions which need to be satisfied in order for the hold slot be to be available again the user.

Reference is made to FIG. 4d which shows an example method of some embodiments.

As referenced A1, the processor is configured to determine that one or more conditions to remove a card from the game play area has been satisfied. This may be the first card discussed in relation to FIG. 4a.

As referenced A2, the processor is configured to cause the display to update such that the first card is removed from the game play area. In some embodiments, the processor is configured to cause the first card which is removed from the game play area to be placed on the foundation card.

As referenced A3, the processor is configured to determine if the blocking card is activated as a result of removing the first card from the game play area. In this method flow, it is assumed that the blocking card will be activated as a result of removing the first card from the game play area.

As referenced A4, the processor is configured to cause the display to be updated to show the blocking card moving from the game play area to the hold slot.

As referenced A5, the processor is configured to determine if the one or more conditions to remove the blocking card are satisfied. Until the one or more conditions to remove the blocking card are satisfied, the user is prevented by the processor from moving a card to or from the hold slot.

As referenced A6, in the event that the processor determines that the one or more conditions to remove the blocking card have been satisfied, the processor causes the image displayed by the display to be updated to remove the blocking card from the hold slots. The processor is also configured to allow the hold slot to be used by the user during the computer implemented game. In other words, the user is able to select a card which can be moved to the hold slot or from the hold slot.

In some embodiments, the processor is configured to provide a game reward in response to the removal of the blocking card. For example, the processor may be configured to provide the user with a booster which can be used to assist the user in playing the game. In another example, the processor may be configured to provide the user with extra cards that can be added to the play stack.

In some embodiments, the processor is configured to provide the user with assistance to remove the blocking card. For example, one or more additional cards may be provided in the play stack. The assistance to remove the blocking card may be provided in response to the triggering of the blocking card.

It should be appreciated that when a card is in the hold slot and the blocking card is moved to the hold slot, that card in the hold slot is removed, for example to a discard pile.

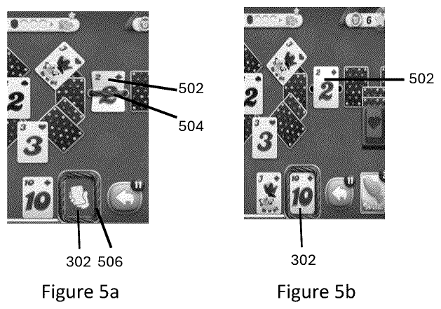

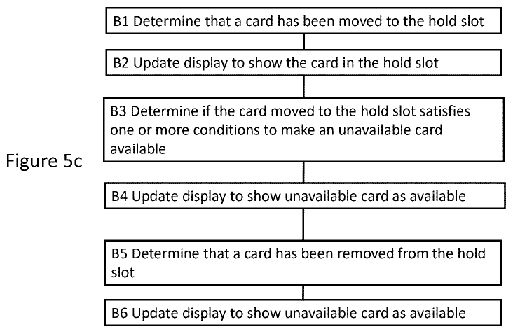

Reference is made to FIGS. 5a and 5b which show an example of a modification to the hold slot features that may be used in one or more levels of the computer implemented game as outlined in relation to FIG. 3.

In the example of FIG. 5a, a card 502 in the game play area is unavailable for play. This is referred to as an unavailable card. The processor is configured to cause the unavailable card to be displayed by the display in a way which visually indicates that the unavailable card is unavailable for play to the user. In the example shown in FIG. 5, the card is indicated as being unavailable by the presence of a gate 504 across the card. It should be appreciated that this is by way of example only and in other embodiments, a different visual indication may be used to indicate that the unavailable card is unavailable for play.

The processor is configured to take no action in relation to the unavailable card in the event that the user attempts to select that unavailable card through the user interface. In other words, the user is unable to select and play the unavailable card.

In the example shown in FIG. 5a, the unavailable card may become available if one or more conditions are satisfied.

In the example shown in FIG. 5a, the one or more conditions may be associated with the hold slot. For example, a foundation card which is moved to the hold slot and satisfies one or more conditions may cause the unavailable card to become available. For example, if the foundation card moved to the hold slot has a suit with the same colour as the colour of the suit of the unavailable card, the unavailable card is made available.

Thus when there is an unavailable card and the user provides an input to move a foundation card to the hold slot, the processor is configured to determine if the colour of the suit of the foundation card is the same as the suit of the unavailable card. If the colour of the suit of the foundation card is the same as the suit of the unavailable card, the processor is configured to cause the unavailable card to become available. The processor is configured to cause the display to display the previously unavailable card in a manner which indicates to the user that unavailable card is now available, for example as shown in FIG. 5b. For example, the gate 504 may be removed from the image of the card which is displayed.

The processor may be configured to update the information stored in the memory associated with the previously unavailable card to indicate that the card is available. The processor may be configured to allow the previously unavailable card to be selected by the user via input received from the user interface.

In the example shown in FIG. 5a, the processor is configured to provide a visual indication associated with the hold slot to indicate a requirement of a foundation card to make the unavailable card available. In the example of FIG. 5a, a border 506 of the hold slot is provided in the colour of the suit of the foundation card that is required to make the unavailable card available.

In some embodiments, a plurality of unavailable cards may be provided in the game play area. All of the unavailable cards may be made available at the same time when a card satisfying the required one or more conditions is put into the hold slot. In other embodiments, only one unavailable card can be made available at a time.

In some embodiments, the one or more conditions may alternatively or additionally comprise that the suit of the card in the hold slot matches that of the unavailable card.

In some embodiments, the one or more conditions may alternatively or additionally comprise that the number of the card in the hold slot satisfies one or more criteria with respect to that of the unavailable card. For example the number of the card in the hold slot is the same as that of the unavailable card. For example the number of the card in the hold slot is one or one less than that of the unavailable card.

In some embodiments, the one or more conditions may alternatively or additionally comprise that an unlock card is provided in the hold slot. In this example a special unlock cards is provided which is able to cause the unavailable card to become available when the unlock card is provided in the hold slot.

In some embodiments, the card that was previously unavailable only remains available as long as the card in the hold slot satisfying the one or more conditions remains in the hold slot. For example, if the card in the hold slot is moved to the foundation position, the card reverts to being unavailable once more.

Reference is made to FIG. 5c which shows an example method of some embodiments.

As referenced B1, the processor is configured to determine that a card has been moved to the hold slot. This may be in response to user input received via the user interface to select a card to be moved to the hold slot.

As referenced B2, the processor is configured to cause the display to be updated such that the hold slot is displayed with the card in the hold slot.

As referenced B3, the processor is configured to determine if the card moved to the hold slot satisfies the one or more conditions to make one or more unavailable cards available.

As referenced B4, where the one or more conditions to make one or more unavailable cards available are satisfied, the processor is configured to cause the previously unavailable card to be displayed as available.

As referenced B5, the processor is configured to determine that a card has been removed from the hold slot. This may be in response to user input received via the user interface to select a card to be removed from the hold slot.

As referenced B6, where the one or more conditions to make one or more unavailable cards available are no longer satisfied, the processor is configured to cause the previously available card to be displayed again as unavailable. This assumes that the card has remained in the game play area.

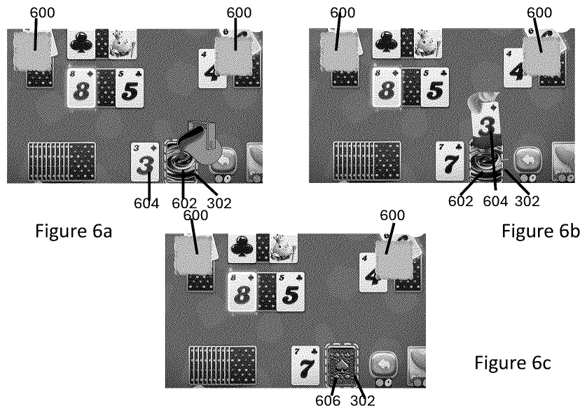

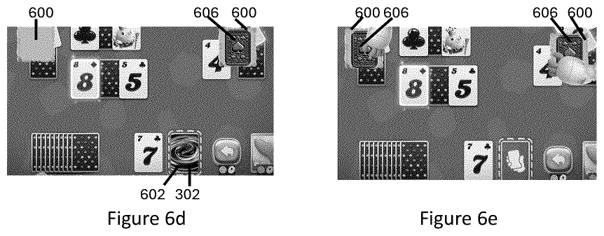

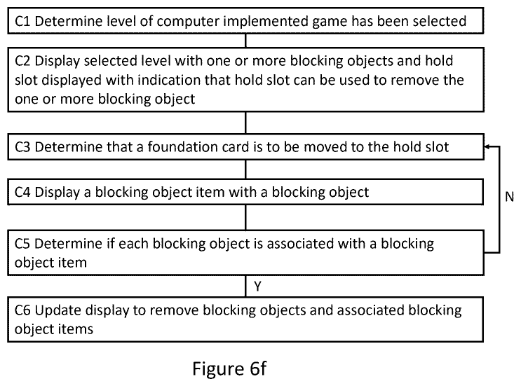

Reference is made to FIGS. 6a to 6e which shows an example of a modification to the hold slot features which may be used in one or more levels of the computer implemented game as outlined in relation to FIG. 3.

In the example shown in FIG. 6a, the processor is configured to cause the display to display a level of the computer implemented game. In this level, the game play area is provided with one or more blocking objects 600. A blocking object may cover at least partially one or more of the cards in the game play area. Until a blocking object is removed, a card which is completely or partially under the blocking object cannot be removed. In this example, the blocking object is visually displayed as a biscuit or cookie. However this is by way of example only.

The memory is configured to store information indicating that a card at least partially under the blocking object is not available for play. Accordingly, if the user selects via the user interface a card that is at least partially under the blocking object, the processor will not permit that card to be played in the game.

In the example shown in FIG. 6a, the processor is configured to cause the display to display the hold slot in a visual distinct manner 602 to indicate that the hold slot can be used to remove the blocking objects. In this example, the hold slot is displayed on the display as containing chocolate. However, this is by way of example only and a different visual representation may be used in other embodiments.

As shown in FIG. 6b, the processor is configured to determine based on input from the user via the user interface that a card 604 (which is the foundation card in FIG. 6a) is being moved into the hold slot 302.

As shown in FIG. 6c, the processor is configured to cause the display to display a first blocking object item 606 in the hold slot when the card 604 has moved to the hold slot. The first blocking object item 606 is visualized as a chocolate card in some embodiments. However, a different visual representation of the first blocking object item 606 may be provided in different embodiments.

As shown in FIG. 6d, the processor is then configured to cause the display to display the first blocking object item 606 in conjunction with a first one of the blocking objects 600. In the example shown in FIG. 6d, the first blocking item 606 is displayed on top of the first blocking object 600. The first blocking item and the first locking object are thus visualised as a chocolate biscuit or chocolate cookie. The processor is configured to cause the display to display again the hold slot in the visual distinct manner 602 to indicate that the hold slot can be used to remove the blocking objects. In this example, the hold slot is again displayed on the display as containing chocolate.

This process outlined in relation to FIGS. 6a to 6d may be repeated until a blocking object item 606 is provided for each of the blocking objects 600. The processor may be configured to determine that each of the blocking objects is associated with a respective blocking item and when that occurs to remove each of the blocking objects and associated blocking object item. This removal of the blocking objects and associated blocking object items is shown in FIG. 6e.

This removal of the blocking objects and associated blocking object items reveals the one or more cards that at least partially underlay the respective one or more blocking objects.

In some embodiments, the processor is configured to cause the visual indication provided in the hold slot, for example the chocolate, to be removed from the image displayed by the display. The hold slot reverts to its usual appearance.

A method of some embodiments will now be described with reference to FIG. 6f.

As referenced C1, an input is received to select a level of the computer implemented game. The input is received from a user via the user interface.

As referenced C2, the processor is configured to obtain from the memory the data associated with the selected level. The processor is configured to use the data associated with the selected level to cause the display to display an image associated with the level. The processor is configured to cause the display to display one or more blocking objects. The one or more blocking objects overlie at least partially one or more of the cards of the playing area. The hold slot is displayed with a visual indication, for example chocolate, indicating that the hold slot may be used in order to remove the blocking objects.

As referenced C3, the user provides a user input via the user interface. This input is used by the processor to determine that a foundation card is to be moved to the hold slot.

As referenced C4, the processor is configured to cause the display to display a blocking object item. The blocking object item is, in some embodiments, moved from the hold slot be displayed in conjunction with a blocking object.

As referenced C5, the processor is configured to determine if each of the blocking objects has an associated blocking object item.

When the processor determines that not all of the blocking objects have an associated blocking object item, then the next step is step C3.

When the processor determines that all of the blocking objects have an associated blocking object item, then the next step is step C6.

As referenced C6, the processor determines that all of the blocking objects have an associated blocking object item, all of the blocking objects and associated blocking object items are removed from the game play area. This means that any card that was at least partially under a blocking object may be selected by the user via the user interface in the game.

The visual indication that the hold slot can be used to remove blocking objects is removed. In some embodiments, this may mean for example that the hold slot is no longer displayed with liquid chocolate.

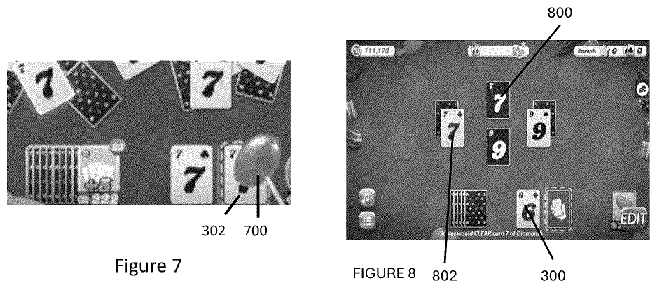

Reference is made to FIG. 7 which shows an example of a modification to the hold slot features which may be used in one or more levels of the computer implemented game as outlined in relation to FIG. 3.

The user may select via the user interface a booster object 700. In example shown in FIG. 7, the booster object is visualised as a lollipop. However this is by way of example only and the booster object may be visualised in any other suitable manner. The processor may be configured to determine in response to the user input that the booster object has been selected and applied to the hold slot 302. The processor may be configured to cause a card which is in the hold slot to be removed from the hold slot when booster is selected and applied to the hold slot. By removing the card in the hold slot, the hold slot once again becomes available to receive a current foundation card.

Reference is made to FIG. 8. In the computer-implemented game of some embodiments, a card may be associated directly or indirectly with a number. In some embodiments, the number is between 1 and 13 inclusive, as with a conventional pack of cards. A jack (sometimes referred to as a knave) represents 11, a queen represents 12, and a king represents 13.

A card may be associated with a colour. In one embodiment, there are two colours, red and black. Optionally, each card is associated with a suit, for example, clubs, spades, hearts, or diamonds.

In some embodiments, such as shown in FIG. 8, there may be two types of cards.

The first type of card may be associated with a colour restriction. This means that the card can only be removed from the game board by a card of the same colour. If the first type of card is on the top of the play stack, it can only be used to remove a card of the same colour.

Consider the following example: Card 800 is associated with the colour black and the number 7. Card 800 is in the game play area. This means that card 800 can only be removed if the foundation card on the play stack is a black 6 or a black 8.

Consider the example where the same card is instead the foundation card on the play stack. This means that only a black 6 or a black 8 can be removed from the game play area.

The second type of card may be without a colour restriction. This means that the card can be removed from the game board by a card of the same colour or a different colour.

Consider the following example: Card 802 is associated with the colour black and the number 9. Card 802 is in the game play area. This means that card 802 can be removed if the foundation card on the play stack is a black 8, red 8, red 10, or black 10.

Consider the example where the same card is instead the foundation card on the play stack. This means that a black 8, red 8, red 10, or black 10 can be removed from the game play area.

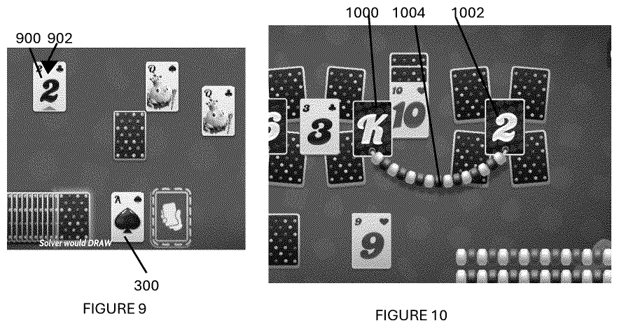

Reference is made to FIG. 9, which shows a third type of card. Some embodiments may have all of the first, second, and third types of cards. Other embodiments may only have one or more of the first, second, and third types of cards. Where the different types of cards are provided, they may be provided in different levels of the game or in the same level of the game.

The third type of card 900 can only be removed by a specific value of card on the top of the play stack. In the example shown in FIG. 9, card 900 is associated with the number 2. The card 900 is provided with an indication 902 that the card can only be removed if the foundation card on the play stack has a lower value. Card 802 is in the game play area. This means that card 802 can be removed if the foundation card on the play stack is a black 1 (ace) or a red 1 (ace).

Consider the example where the same card is instead the foundation card on the play stack. This means that only a black 1 (ace) or a red 1 (ace) can be removed from the game play area.

In other examples, the card may be provided with an indication that the card can only be removed if the foundation card on the play stack has a higher value. For example, if card 802 was instead associated with the indication that the card can only be removed if the foundation card on the play stack has a higher value, that card can only be removed from the game play area if the foundation card on the play stack is a black 3 or a red 3.

Consider the example where the same card is instead the foundation card on the play stack. This means that only a black 3 or a red 3 can be removed from the game play area.

It should be noted that in some embodiments, the first type of card discussed in relation to FIG. 8 may be modified to include an indication such as discussed in relation to FIG. 9. For example, the card may only be used with a card of the required colour, and which satisfies the indication.

For example, if the card referenced 800 in FIG. 8 further comprises an indication that the card can only be removed by a lower card, then the card referenced 800 would only be removed by a black card 6.

For example, if the card referenced 800 in FIG. 8 further comprises an indication that the card can only be removed by a higher card, then the card referenced 800 would only be removed by a black card 8.

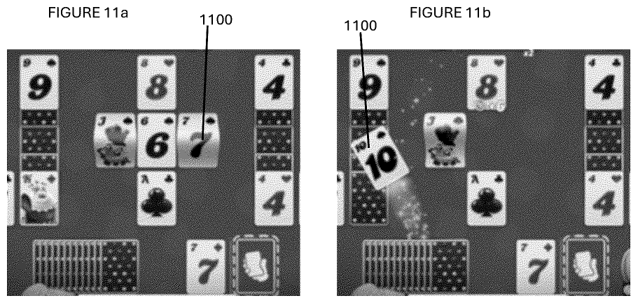

Reference is made to FIG. 10. In the computer-implemented game of some embodiments, a card may be linked to another card. In the example shown in FIG. 10, the processor is configured to cause the display to show a visual indication between two linked cards. In the example shown in FIG. 10, a first card 1000 is linked to a second card 1002. A chain 104 is shown which links the first card 1000 and the second card 1002. If during game play, the processor determines that the user has made a move by providing an input via the user interface such that one of the first card 1000 and the second card 1002 can be removed, then both the first card 1000 and the second card 1002 will be removed from the game play area.

In some embodiments, the first card 1000 and the second card 1002 can only be removed if both of the linked cards are available for play. For example, if one of the linked cards is under another card or under a blocker, the processor will prevent the user from selecting either of the linked cards for a move.

In some embodiments, the first card 1000 and the second card 1002 can be removed provided that at least the selected linked card is available for play. For example, if one of the linked cards is under another card or under a blocker, the processor will prevent the user from selecting that linked card for a move. However, the processor is configured to allow the user to provide an input to select a linked card which is available for play. When the available linked card is selected for play, then both of the linked cards may be removed from the game play area, including the linked card which is under another card or under a blocker.

Reference is made to FIGS. 11a and 11b which show an example of a so-called flying card 1100. The flying card can be selected as usual to be played. The flying card 1100 is provided in the game play area. When the user selects the flying card 1100 via the user interface, the processor is configured to cause the display to be updated such that the so-called flying card moves to a new location (as shown in FIG. 11b). In some embodiments, when the flying card moves to the new location, it is provided with a different characteristic. For example, the card may be provided with a different number, suit, or colour. In the example shown in FIGS. 11a and 11b, the flying card is initially associated with the 7 of spades. This is shown in FIG. 11a.

When the user has selected the flying card 1100 via the user interface to make a move with that card, the processor is configured to cause the flying card to be moved to a different location and to be associated with the 10 of spades. This is shown in FIG. 11b.

In some embodiments, the so-called flying card may be displayed on the display in a visually distinctive manner. For example, the so-called flying card may be displayed with a ripple effect.

In some embodiments, once the flying card 1100 has been played, the flying card reverts to having the same properties as other cards. For example, when the user selects card 1100 via the user interface when that card has moved to the new location, the card may be removed from the game play area during game play.

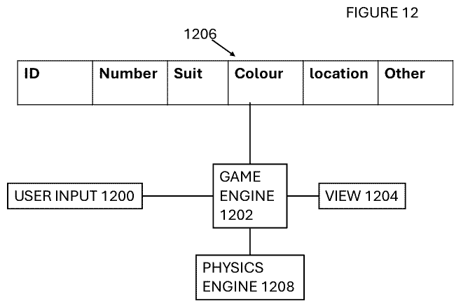

Reference is made to FIG. 12 which schematically shows the functional blocks of some embodiment, which may enable game play such as discussed previously. This may be provided in the user device of FIG. 1. A user input 1200 is provided via the user interface. This captures the user input received via the user interface and feeds the input to a game engine 1202. In the context of the game of some embodiments, this user input may be which cards are selected by a user. This user input can be via any suitable user interface, such as discussed earlier. Figure The game engine may be provided by the one or more processors.

The game engine 1202 will process the information provided by the user input. The game engine 1202 (for example a game model) will determine if a valid move has been made.

Each card has data associated therewith. The data may be provided as a data structure 1206. The data structure 1206 may be stored in any suitable memory location. In some embodiments, the data may be part of the game engine and in other embodiments may be outside the game engine.

The data structure 1206 is responsible for controlling where the cards and other game elements are displayed on the display, the appearance and the properties of the cards and other game elements. Each card or other game element has an identity ID. The identity ID is used by the game engine. The identity ID may be allocated a particular position or location on a game play area. In some embodiments, the location may be part of the data structure. In other embodiments, a separate data structure is provided to correlate a location of the game element or card with the respective ID.

The data structure may provide information as to the properties of the card such as described previously. For example, the number, suit, and colour may be provided. One or more other properties may alternatively or additionally be stored.

In some embodiments, the game engine will check if a move made by the user satisfies the rule or rules for a valid move. Some examples of rules which define whether or not a condition for a move has been satisfied and the outcome of that move have been discussed.

The game engine will have access to data for a card including its position and will be able to determine if a required condition has been met.

A physics engine 1208 may be provided which is configured to control the movement of moving game elements on the display. The physics engine 808 may be part of the game engine 1202 or provided by the at least one processor.

A view function 1202 uses the data to provide the displayed image on the display with which the user can view and/or interact. The view function may be provided by a rendering engine. The rendering engine may be provided by the graphics controller 125 of FIG. 1.

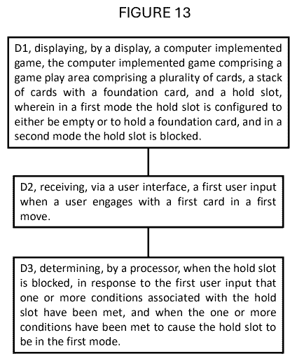

Reference is made to FIG. 13 which shows a method of some embodiments, The method may be performed by a user device.

The method comprises as D1, displaying, by a display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked.

The method comprises as D2, receiving, via a user interface, a first user input when a user engages with a first card in a first move.

The method comprises as D3, determining, by a processor, when the hold slot is blocked, in response to the first user input that one or more conditions associated with the hold slot have been met, and when the one or more conditions have been met to cause the hold slot to be in the first mode.

Various methods and devices have been described. It should be appreciated that these methods may be implemented in apparatus or devices comprising any suitable circuitry. Some embodiments may be implemented by memory and processor. The memory is provided by memory circuitry and the processor is provided by processor circuitry. Some embodiments may be provided by a computer program running on the processor. The computer program may comprise computer implemented instructions which are stored in the memory, and which may be run on the processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by processor causes any of the above-described methods to be performed.

A person skilled in the art will realise that the different approaches to implementing the game is not exhaustive, what is described herein are certain preferred embodiments. It is possible to implement the way in a number of variations without departing from the scope of the invention as claimed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A user device configured to provide a computer implemented game, the user device comprising:
a display configured to display a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked;
a user interface configured to receive a first user input when a user engages with a first card in a first move; and
a processor configured to determine, when the hold slot is blocked, in response to the first user input that one or more conditions associated with the hold slot have been met, and when the one or more conditions have been met to cause the hold slot to be in the first mode.

2. The user device as claimed in claim 1, wherein the processor is configured to cause the hold slot to be in the second mode when a blocking object is provided in the hold slot.

3. The user device as claimed in claim 2, wherein the blocking object comprises a blocking card.

4. The user device as claimed in claim 2, wherein the user interface is configured to receive a second user input when a user engages with a second card in a second move, the hold slot being in the first mode, and the processor is configured to determine, in response to the second user input, that the blocking object is activated, and to cause the blocking object to be moved to the hold slot such that the hold slot is changed from the first mode to the second mode.

5. The user device as claimed in claim 4, wherein the blocking object at least partially underlies the second card, and the processor is configured to determine that the blocking object is activated when the second card is removed from the game play area.

6. The user device as claimed in claim 2, wherein the one or more conditions comprise two or more actions and the processor is configured to cause the display to display the blocking object in the hold slot in dependence on a number of the two or more actions which have been completed.

7. The user device as claimed in claim 6, wherein the two or more actions comprise two or more moves which satisfy a criterion.

8. The user device as claimed in claim 6, wherein the processor is configured to cause the display to display the blocking object in the hold slot such that as more of the two or more actions have been completed, less of the hold slot is occupied by the blocking object.

9. The user device as claimed in claim 2, wherein the processor is configured to cause the display to display the hold slot without the blocking object when the one or more conditions have been met.

10. The user device as claimed in claim 1, wherein the processor is configured to cause the hold slot in the second mode to be blocked such that a foundation card which is moved to the hold slot cannot be moved back to being the foundation card of the stack of cards.

11. The user device as claimed in claim 10, wherein the display is configured to display one or more blocking objects on the game play area when the hold slot is blocked.

12. The user device as claimed in claim 11, wherein the processor is configured to prevent selection of a card in the game play area which underlies at least partially one of the one or more blocking objects.

13. The user device as claimed in claim 11, wherein the user interface is configured to receive a third user input when a user engages with a third card in a third move, the hold slot being in the second mode, and the processor is configured to cause, in response to the third user input causing one or more conditions to be satisfied, a blocking object item to be provided for a blocking object item.

14. The user device as claimed in claim 13, wherein the processor is configured to cause the display the blocking object item together with one of the one or more blocking objects.

15. The user device as claimed in claim 13, wherein the processor is configured to cause the one or more blocking items to be removed from the game play area when each blocking object is associated with a blocking object item.

16. The user device as claimed in claim 13, wherein the processor is configured to cause the hold slot to have the first mode when all of the one or more blocking objects have been removed from the game play area.

17. The user device as claimed in claim 13, wherein the one or more conditions which cause the blocking object item to be provided, comprise moving a foundation card to the hold slot.

18. The user device as claimed in claim 17, wherein the processor is configured to modify the foundation card which was moved to the hold slot to provide the blocking object item.

19. A computer implemented method performed by a user device, the user device having at least one processor, a display and a user interface, the method comprising:
displaying, by the display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked by a blocking object;
receiving, via the user interface, a first user input when a user engages with a first card in a first move, the hold slot being in the first mode;
determining, by the at least one processor, in response to the first user input, that the blocking object is activated; and
causing, by the at least one processor, the blocking object to be moved to the hold slot such that the hold slot is changed from the first mode to the second mode.

20. A computer program product comprising computer executable instructions which when executed by a processor of a user device, cause the processor to perform the following:
cause a display of the user device to display, a computer implemented game, the computer implemented game comprising a game play area comprising a plurality of cards, a stack of cards with a foundation card, and a hold slot, wherein in a first mode the hold slot is configured to either be empty or to hold a foundation card, and in a second mode the hold slot is blocked such that a foundation card which is moved to the hold slot cannot be moved back to being the foundation card of the stack of cards;
receive, via a user interface, a first user input when a user engages with the foundation card to move the foundation card to the hold slot in a first move, the hold slot being in the second mode;
determine in response to the first move, when the hold slot is blocked, that one or more conditions associated with the hold slot have been met, and
cause the hold slot to be in the first mode when the one or more conditions have been met to cause the hold slot to be in the first mode.
